(19) United States
(12) Patent Application Publication
(10) Pub. No.: US 2013/0305219 A1
(43) Pub. Date: Nov. 14, 2013

(54) APPARATUS AND METHOD FOR PROVIDING CUSTOM SOFTWARE, AND METHOD FOR SOFTWARE CUSTOMIZATION

(71) Applicant: Won-Jae Lee, Daejeon (KR)

(72) Inventor: Won-Jae Lee, Daejeon (KR)

(73) Assignee: Electronics and Telecommunications Research Institute, Daejeon (KR)

(21) Appl. No.: 13/996,756

(22) PCT Filed: Dec. 16, 2011
(86) PCT No.: PCT/KR2011/009737

§ 371 Date: Jun. 21, 2013

(30) Foreign Application Priority Data
Dec. 23, 2010 (KR) 1020100133950

(51) Int. Cl. G06F 9/44

(52) U.S. Cl. CPC G06F 8/36
USPC 717/110

(57) ABSTRACT

The apparatus for providing custom software: transmits a core code to a terminal to be used for software customization by using the core code divided into a plurality of lines; receives a custom code corresponding to a software customization result from the terminal; and stores software information separated from the core code after extracting the custom software information including content altered in the coed code from the custom code.

### TECHNICAL FIELD

The present invention relates to an apparatus and method for providing customization software, and a method for software customization. More particularly, the present invention relates to an apparatus and method for providing customization software, and a method for software customization that may perform customization based on a source code.

The present invention claims the benefit from Korean Patent Application No. 10-2010-0133950, filed on Dec. 23, 2010, in the Korean Intellectual Property Office, the entire disclosure of which is incorporated herein by reference.

### BACKGROUND ART

When a service provider providing software as a service (SaaS) provides a service to companies, the service is provided to each company by allocating a server for each company. In this instance, when customization software is provided to each company, the service provider customizes software by modifying a source code of software suited to each company.

When the software is customized for each company, expenditure, by the service provider, for updating and managing different versions of software may be great because different versions of one piece of software may be generated for each company.

### DISCLOSURE OF INVENTION

### Technical Goals

An aspect of the present invention provides an apparatus and method for providing customization software, and a method for software customization that may provide customization software for each company and may also reduce costs used to update and manage software.

### Technical Solutions

According to an aspect of the present invention, there is provided a method for software customization, the method including transmitting, by an apparatus to a terminal, a core code divided into a plurality of paragraphs to be used for software customization, receiving, by the apparatus, a customized code corresponding to a software customization result from the terminal, extracting, by the apparatus, software customization information including content altered in the core code from the customized code, and storing, by the apparatus, the software customization information separately from the core code.

According to another aspect of the present invention, there is provided a method for providing customization software, the method including generating, by an apparatus, a customized code by applying customization information including altered content of a plurality of paragraphs to a core code divided into the plurality of paragraphs, in response to a service request message being received from a terminal, executing, by the apparatus, customization software using the customized code, and processing, by the apparatus, the service request message using the executed customization software.

According to still another aspect of the present invention, there is provided an apparatus for providing customization software, the apparatus including a code storage unit, an information storage unit, and an execution engine. The code storage unit stores a core code divided into a plurality of paragraphs. The information storage unit stores software customization information including code alteration information and paragraph insert information corresponding to content altered among the plurality of paragraphs in a form of metadata. The execution engine generates a customized code by applying the software customization information to the core code and executes customization software using the customized code.

### Effects of the Invention

According to embodiments of the present invention, a software provider may update and manage a core code only, and a customized code for each of companies may be updated and managed by the companies because a customized code corresponding to a source code of customization software is generated using a core code corresponding to a source code of original software and software customization information. Accordingly, it is possible to provide customization software for each company and reduce costs for updating and managing software.

### BRIEF DESCRIPTION OF DRAWINGS

FIG. 1 is a block diagram illustrating a configuration of a system for providing software according to an embodiment of the present invention.

FIG. 2 is a diagram illustrating a configuration of a core code according to an embodiment of the present invention.

FIG. 3 is a flowchart illustrating a method of software customization according to an embodiment of the present invention.

FIG. 4 is a flowchart illustrating a method for providing customization software according to an embodiment of the present invention.

FIG. 5 is a diagram illustrating a configuration of a setting code according to a first embodiment of the present invention.

FIG. 6 is a diagram illustrating a configuration of a setting code according to a second embodiment of the present invention.

FIG. 7 is a diagram illustrating a configuration of a setting code according to a third embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures. Here, a repeated description, and a detailed description related to a known function and configuration that may render the purpose of the present invention unnecessarily ambiguous will be omitted here. Embodiments of the present invention are provided to further completely describe the present invention for those having the average knowledge in the art. Accordingly, shapes and sizes of constituent elements and the like in the drawings may be exaggerated for further clear description.

Hereinafter, an apparatus and a method for providing software, and a method for software customization according to an embodiment of the present invention will be described with reference to the accompanying drawings.

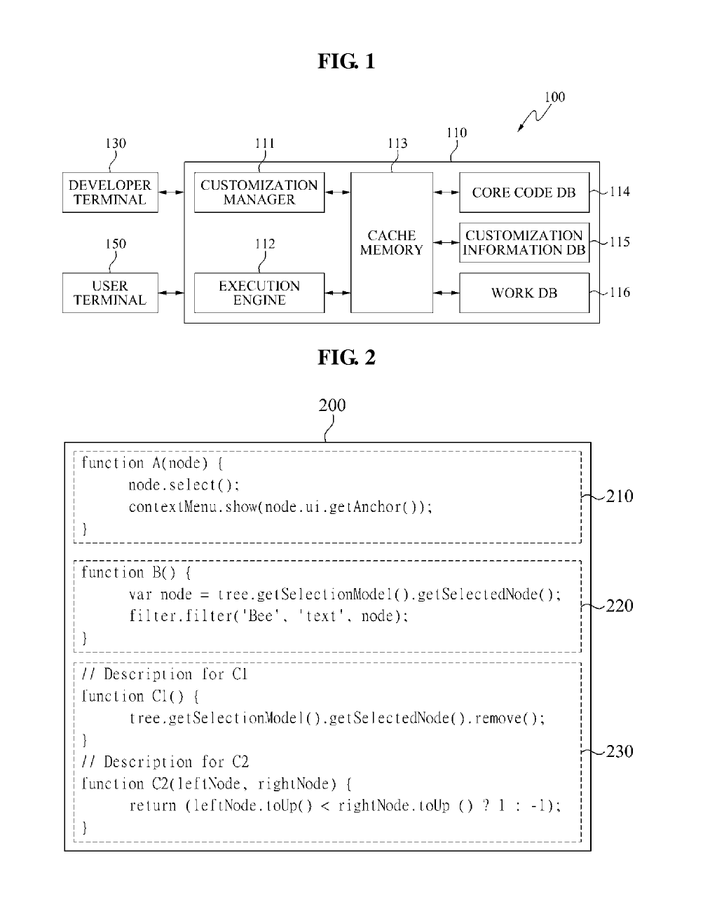

A system for providing software according to an embodiment of the present invention will be initially described with reference to FIG. 1.

FIG. 1 is a diagram illustrating a configuration of a system for providing software 100 according to an embodiment of the present invention.

As illustrated in FIG. 1, the system for providing software 100 includes an apparatus for providing customization software 110, a developer terminal 130, and a user terminal 150. Here, the apparatus for providing customization software 110 includes a customization manager 111, an execution engine 112, a cache memory 113, a core code database (DB) (hereinafter, also referred to as a core code DB) 114, a customization information database (hereinafter, also referred to as a customization information DB) 115, and a work database (hereinafter, also referred to as a work DB) 116. The customization manager 111 transmits a code needed for customizing software to the developer terminal 130 using data stored in the core code DB 114 and the customization information DB 115, receives a customized code corresponding to a software customization result from the developer terminal 130, and generates software customization information using the customized code. In this instance, software customization information may include altered source code information or paragraph insert information as information for generating the customized code from the core code. Further, the customization manager 111 may also receive software customization information from the developer terminal 130.

The execution engine 112 executes customization software using data stored in the core code DB 114 and the customization information DB 115 in response to a request of the user terminal 150, processes data stored in the work DB 116 using the executed customization software, and transmits a processing result to the user terminal 150.

The cache memory 113 refers to a high speed memory to increase a processing rate of the apparatus for providing customization software 110, and temporarily stores data frequently used among data stored in at least one of the core code DB 114, the customization information DB 115, and the work DB 116, or temporarily stores the processing result of the customization manager 111 or the execution engine 112.

The core code DB 114 stores a core code and paragraph information provided from a software provider. Here, the core code corresponds to a source code of software, and paragraph information corresponds to information for dividing the core code into a plurality of paragraphs. In this instance, the core code DB 114 may further include setting information provided from the software provider.

The customization information DB 115 stores software customization information transferred from the customization manager 111. Here, the customization information DB 115 may store the software customization information in a form of metadata.

The work DB 116 stores data needed for processing tasks.

The developer terminal 130 provides a code received from the customization manager 111 to a developer so that the developer may perform software customization, and transmits, to the customization manager 111, a software customization result performed by the developer.

The user terminal 150 transmits a service request message requesting a service using customization software to the execution engine 112, and receives, from the execution engine 112, a service response message corresponding to a response to the service request message.

Hereinafter, a configuration of a core code according to an embodiment of the present invention will be described with reference to FIG. 2.

FIG. 2 is a diagram illustrating a configuration of a core code 200 according to an embodiment of the present invention.

As illustrated in FIG. 2, the core code 200 may be divided into a plurality of paragraphs, for example, a first paragraph 210, a second paragraph 220, and a third paragraph 230, based on paragraph information.

Here, a developer may perform software customization using the core code 200 divided into a plurality of paragraphs through the developer terminal 130.

For example, the developer may modify, replace, or delete a portion of the plurality of paragraphs, and may also insert an additional new paragraph.

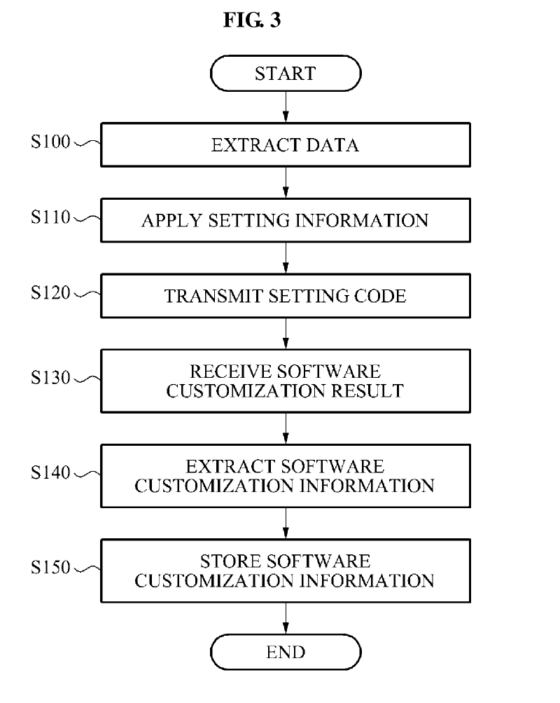

Hereinafter, a method for generating, by an apparatus for providing customization software, software customization information for software customization according to an embodiment of the present invention will be described with reference to FIG. 3.

FIG. 3 is a diagram illustrating a method for software customization according to an embodiment of the present invention.

As illustrated in FIG. 3, initially, the customization manager 111 extracts data stored in the core code DB 114, for example, a core code, paragraph information, and setting information in operation S100.

The customization manager 111 generates a setting code by applying the setting information to a plurality of paragraphs included in the core code in operation S110. Here, the setting information is used to determine whether to set a hiding setting or whether to infer a type for each of the plurality of paragraphs. In this instance, the customization manager 111 may set the hiding setting for a portion of the plurality of to paragraphs, or may set the hiding setting for a portion of a line or a argument in any one of the plurality of paragraphs according to the setting information.

The customization manager 111 transmits the setting code to the developer terminal 130 in operation S120.

Subsequently, the customization manager 111 receives a customized code corresponding to a software customization result from the developer manager 130 in operation S130.

The customization manager 111 then extracts software customization information including altered content of the core code from the customized code in operation S140. Here, the software customization information includes altered source code information including altered content for each of the plurality of paragraphs included in the core code, or paragraph insert information including additional new paragraphs to be inserted to the core code.

The customization manager 111 stores the software customization information in the customization information DB 115 in operation S150. Here, the customization manager 111 may store the software customization information in the customization information DB 115 in a form of metadata.

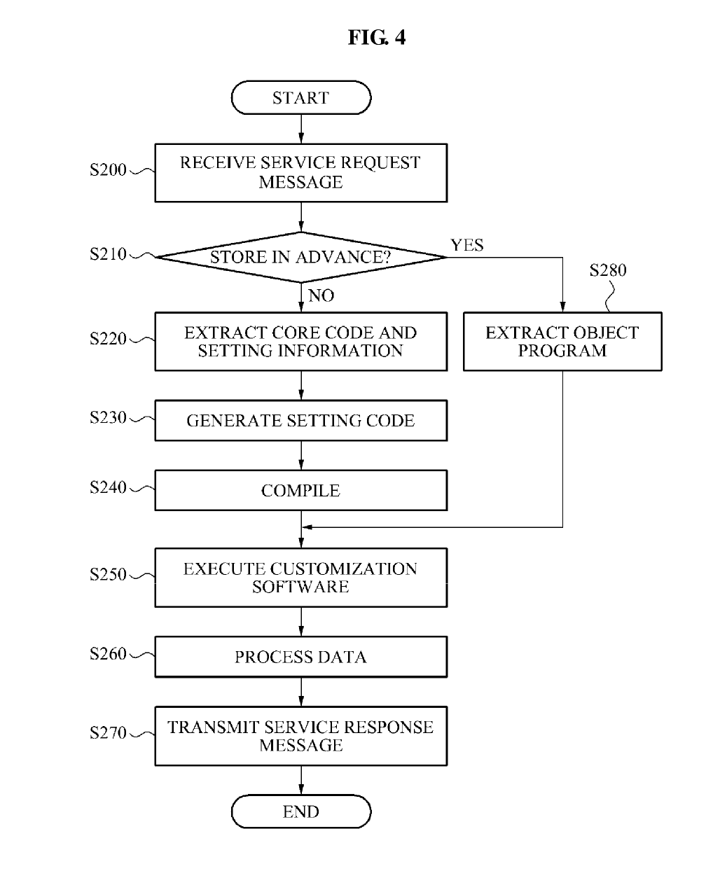

Hereinafter, a method for providing customization software by an apparatus for providing customization software according to an embodiment of the present invention will be described with reference to FIG. 4.

FIG. 4 is a diagram illustrating a method for providing customization software according to an embodiment of the present invention.

As illustrated in FIG. 4, initially, the execution engine 112 receives a service request message requesting a service using customization software from the user terminal 150 in operation S200.

Next, the execution engine 112 determines whether a result of compiling a customized code corresponding to customization software, for example, an object program, is stored in the cache memory 113 in advance in operation S210. Here, the customized code corresponds to a source code of the customization software.

Based on a determination result of operation S210, when the object program is not stored in advance, the execution engine 112 extracts the core code and the software customization information from the core code DB 114 and the customization information DB 115 in operation S220. Here, the execution engine 112 may further extract paragraph information from the core code DB 114.

The execution engine 112 then generates the customized code by applying the software customization information to the core code in operation S230. Here, the software customization information includes altered source code information or paragraph insert information. In this instance, the execution engine 112 may generate the customized code by modifying or deleting any one of a plurality of paragraphs included in the core code based on the altered source code information, or may generate the customized code by inserting an additional paragraph to the core code based on the paragraph insert information.

Subsequently, the execution engine 112 generates an object program corresponding to the customized code by compiling the customized code in operation S240.

Next, the execution engine 112 executes the customization software by operating the generated object program in operation S250.

The execution engine 112 then processes work data stored in the work DB 116 using the executed customization software in operation S260.

Next, the execution engine 112 transmits a service response message including a data processing result to the user terminal 150 in operation S270.

Based on a determination result of operation S270, when the object program is stored in advance, the execution engine 112 extracts the object program from the cache memory 113 in operation S280. Here, the execution engine 112 may execute the customization software by operating the extracted object program.

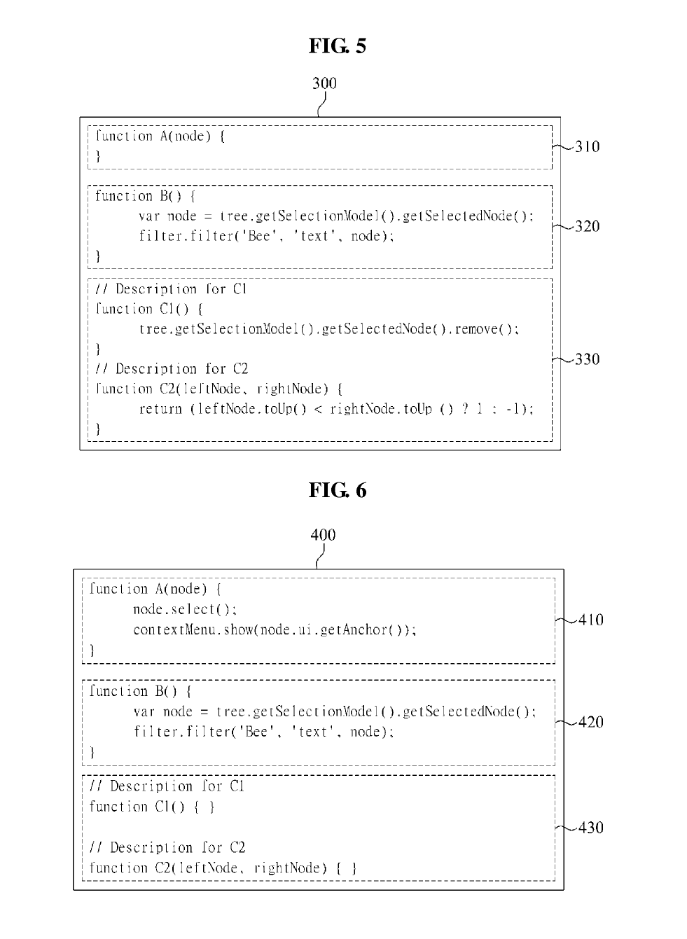

Hereinafter, a setting code according to an embodiment of the present invention will be described with reference to FIGS. 5 to 7.

FIG. 5 is a diagram illustrating a configuration of a setting code 300 according to a first embodiment of the present invention.

As illustrated in FIG. 5, the setting code 300 may be divided into a plurality of paragraphs, for example, a first paragraph 310, a second paragraph 320, and a third paragraph 330, based on paragraph information.

Here, a software provider may apply a hiding setting for a partial line of the first paragraph 310 through the setting information.

FIG. 6 is a diagram illustrating a configuration of a setting code 400 according to a second embodiment of the present invention.

As illustrated in FIG. 6, the setting code 400 may be divided into a plurality of paragraphs, for example, a first paragraph 410, a second paragraph 420, and a third paragraph 430, based on paragraph information.

Here, a software provider may set the third paragraph 430 to represent only main interfaces, “function C1”, “function C2”, “leftNode”, and “rightNode”, through the setting information. In this instance, the main interface corresponds to an interface needed for development based on the core code such as a function name, a argument type, and a return type.

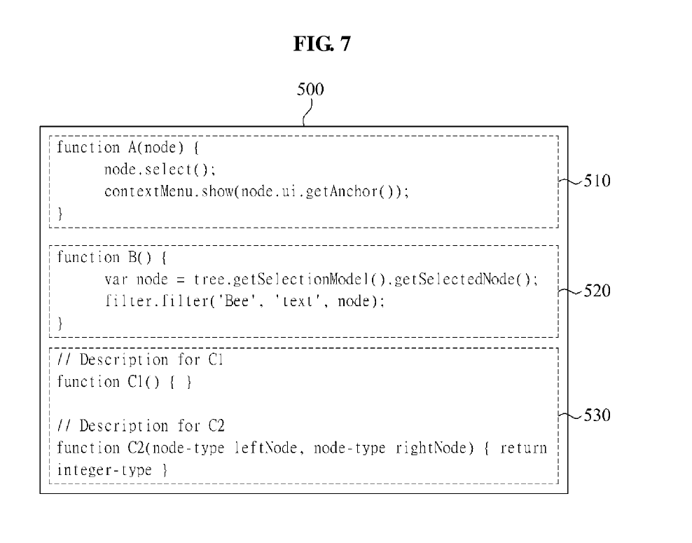

FIG. 7 is a diagram illustrating a configuration of a core code 500 according to a third embodiment of the present invention.

As illustrated in FIG. 7, the setting code 500 may be divided into a plurality of paragraphs, for example, a first paragraph 510, a second paragraph 520, and a third paragraph 530, based on paragraph information.

Here, a software provider may apply a type inference for the third paragraph 530 through the setting information, so that the third paragraph 530 may provide argument type information and return type information. In this instance, the argument type information corresponds to “node-type leftNode” and “node-type rightNode”, and the return type information corresponds to “return integer-type”.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method for software customization, the method comprising:
transmitting, by an apparatus to a terminal, a core code divided into a plurality of paragraphs to be used for software customization;
receiving, by the apparatus, a customized code corresponding to a software customization result from the terminal;
extracting, by the apparatus, software customization information comprising content altered in the core code from the customized code; and
storing, by the apparatus, the software customization information separately to from the core code.

2. The method of claim 1, wherein the extracting comprises extracting code alteration information comprising altered content for each of the plurality of paragraphs.

3. The method of claim 1, wherein the extracting comprises extracting paragraph insert information comprising an additional paragraph to be inserted to the core code.

4. The method of claim 1, wherein the transmitting comprises:
generating, by the apparatus, a setting code in which a hiding setting is applied to the core code by applying, to the core code, setting information about the core code; and
transmitting, by the apparatus to the terminal, the setting code to be used for software customization.

5. The method of claim 4, wherein the generating comprises generating, by the apparatus, the setting code in which the hiding setting is applied to a portion of the plurality of paragraphs, based on the setting information.

6. The method of claim 4, wherein the generating comprises generating, by the apparatus, the setting code in which the hiding setting is applied to any one line or argument among the plurality of paragraphs, based on the setting information.

7. The method of claim 1, wherein the storing comprises storing the software customization information in a form of metadata.

8. A method for providing customization software, the method comprising:
generating, by an apparatus, a customized code by applying customization information comprising altered content of a plurality of paragraphs to a core code to divided into the plurality of paragraphs, in response to a service request message being received from a terminal;
executing, by the apparatus, customization software using the customized code; and
processing, by the apparatus, the service request message using the executed customization software.

9. The method of claim 8, wherein the software customization information comprises code alteration information comprising altered content for each of the plurality of paragraphs, or paragraph insert information comprising an additional paragraph to be inserted to the core code.

10. The method of claim 9, wherein the generating comprises generating, by the apparatus, the customized code by modifying or deleting any one of the plurality of paragraphs based on the code alteration information.

11. The method of claim 9, wherein the generating comprises generating, by the apparatus, the customized code by inserting the additional paragraph to the core code based on the paragraph insert information.

12. The method of claim 8, wherein the executing comprises:
generating, by the apparatus, an object program by compiling the customized code; and
executing, by the apparatus, the customization software by operating the object program.

13. The method of claim 8, wherein the processing comprises:
processing, by the apparatus, data stored in advance using the executed customization software; and
transmitting, by the apparatus, a service response message comprising a data processing result to the terminal.

14. An apparatus for providing customization software, the apparatus comprising:
a code storage unit to store a core code divided into a plurality of paragraphs;
an information storage unit to store software customization information comprising code alteration information and paragraph insert information corresponding to content altered among the plurality of paragraphs in a form of metadata; and
an execution engine to generate a customized code by applying the software customization information to the core code, and execute customization software using the customized code.

15. The apparatus of claim 14, wherein the execution engine generates the customized code by modifying and deleting any one of the plurality of paragraphs, based on the code alteration information.

16. The apparatus of claim 14, wherein the execution engine generates the customized code by inserting the additional paragraph to the core code, based on the paragraph insert information.

17. The apparatus of claim 14, wherein the execution engine executes the customization software by operating an object program generated by compiling the core code.

18. The apparatus of claim 14, further comprising:
a data storage unit to store work data; and
wherein the execution engine processes the work data using the executed customization software.
